(19) United States
(12) Patent Application Publication
(10) Pub. No.: US 2006/0149634 A1
(43) Pub. Date: Jul. 6, 2006

(54) Method and system for determining product assortment for retail placement

(75) Inventors: Gregory A. Pelegrin, Menasha, WI (US); Kimberly Capelle, Appleton, WI (US); Timothy J. Miller, Harrison, WI (US)

Correspondence Address: SENNIGER POWERS, ONE METROPOLITAN SQUARE, 16TH FLOOR, ST LOUIS, MO, 63102, US

(73) Assignee: Kimberly-Clark Worldwide, Inc., Neenah, WI (US)

(21) Appl. No.: 11/026,310

(22) Filed: Dec. 30, 2004

(51) Int. Cl. G06Q 99/00; G06Q 20/00; G06G 1/14

(52) U.S. Cl. 705/22; 705/1

(57) ABSTRACT

A system determines an assortment of a plurality of related products for retail placement and includes an assortment selection tool for selecting one or more of the plurality of products as a function of product data in order to define a selected product assortment, a database of additional product data and an allocation tool for adjusting the selected product assortment as a function of the additional product data in the database to define an allocated product assortment for retail placement. A virtual environment interface permits marketers, retailers and/or consumers evaluate the product assortment in a virtual environment as a function of the additional product data in the database to define an allocated product assortment for retail placement. A business method determines an assortment of a plurality of related products for retail placement. Another business method evaluates the retail placement of related products.

### BACKGROUND OF INVENTION

The invention generally relates to selecting products for retail placement. In particular, the invention relates to a system and business method for determining an assortment of a plurality of related products for retail placement as a function of shelf space data, product dimension data, inventory tracking data, promotion planning data, forecasting data and/or sales data. In addition, the invention relates to a system and method for evaluating in a virtual environment the retail placement of related products as a function of such data.

Several different types of tools have been developed in order to assist in the selection of a product assortment for retail placement. For example, FIG. 1A illustrates an assortment tool which may be used by suppliers or distributors to determine various product offerings within a category. The tool may be used to meet consumer needs and/or to achieve business goals. The tool employs various product data which may be stored in a variety of databases and applies algorithms to strike a balance between pressures for increased variety on the shelf and the costs associated with increased SKUs. For example, the product data may include consumer data indicating the consumer's loyalty to a particular product, indicating the consumer's exclusive commitment to various products, identifying the worth of particular products to a consumer and/or indicating the substitutability of one product for another. The product data may also include financial data such as the amount of sales per SKU, the amount of profit per SKU and/or the margin per SKU. In addition, the product data may include productivity data such as gross margin return on investment, sales per foot of shelf space and/or profit per foot of shelf space. Marketing data such as distribution information, velocity of sales, market share and total volume may also be a part of the product data. As illustrated in FIG. 1A, all this data is assembled as assortment data which is then selectively used by the assortment selection tool.

The process of developing a selected product assortment by the assortment selection tool may include defining categories which are broken into key segments, each of which may be analyzed to determine the appropriate size. This may also include optimizing the number of items in a particular segment to give a greater return. Individual items may be analyzed by various algorithms or manually to determine if an item should be added to a particular segment, retained within the segment or deleted from the segment. Another approach considers the dollar impact of category changes before final selections are validated and recommended. In one embodiment, additions are calculated as the market share of each item's account multiplied by the item's market sales, assuming the item's account will achieve a fair share. For deletions, it is assumed that the item's account will lose the exclusive buyers of that brand. In order to use the tool, a user may begin with selecting accounts, regions, markets, roles, market coverage and time periods before proceeding with the analysis. Also, to assist the user an assortment matrix may be developed to represent brands and segments to help the user identify gaps in coverage of segments or brands. TABLE 1 illustrates an assortment matrix for three different brands of bathroom tissue according to the number of rolls per package and according to the size of the roll. This assortment matrix is designed to show activity and gaps in coverage.

TABLE 1
ASSORTMENT MATRIX
PREMIUM

| | | | 4 CT | | 6 CT | | 9 CT | | 12 CT | | 24 CT | | Total | |
|---|---|---|---|---|---|---|---|---|---|---|---|---|---|---|
| | | | Cur | Rec | Cur | Rec | Cur | Rec | Cur | Rec | Cur | Rec | Cur | Rec |
| BRAND | BIG ROLL | Items | | | | | 1 | 1 | | | | | 1 | 1 |
| A | | Account Share | | | | | 0.8 | 0.8 | | | | | 0.8 | 0.8 |
| | | Market Share | | | | | 1.9 | 1.9 | | | | | 1.9 | 1.9 |
| | DOUBLE | Items | | | | | | | 1 | 1 | | | 1 | 1 |
| | ROLL | Account Share | | | | | | | 4.0 | 4.0 | | | 4.0 | 4.0 |
| | | Market Share | | | | | | | 3.6 | 3.6 | | | 3.6 | 3.6 |
| | REGULAR | Items | | | | | | | | | 1 | 1 | 1 | 1 |
| | | Account Share | | | | | | | | | 2.2 | 2.2 | 2.2 | 2.2 |
| | | Market Share | | | | | | | | | 5.2 | 5.2 | 5.2 | 5.2 |
| BRAND | DOUBLE | Items | 1 | 1 | 1 | 1 | | | 1 | 1 | | | 3 | 3 |
| B | ROLL | Account Share | 3.3 | 3.3 | 3.5 | 3.5 | | | 2.7 | 2.7 | | | 9.5 | 9.5 |
| | | Market Share | 2.2 | 2.2 | 2.4 | 2.4 | | | 3.5 | 3.5 | | | 8.0 | 8.0 |
| | REGULAR | Items | | | | | | | | | 1 | 1 | 1 | 1 |
| | | Account Share | | | | | | | | | 1.2 | 1.2 | 1.2 | 1.2 |
| | | Market Share | | | | | | | | | 2.1 | 2.1 | 2.1 | 2.1 |
| BRAND | DOUBLE | Items | | | 1 | 1 | | | 1 | 1 | | | 2 | 2 |
| C | ROLL | Account Share | | | 4.6 | 4.6 | | | 4.2 | 4.2 | | | 8.8 | 8.8 |
| | | Market Share | | | 2.3 | 2.3 | | | 2.7 | 2.7 | | | 5.0 | 5.0 |
| | REGULAR | Items | | | | | | | | 1 | | 1 | 0 | 2 |
| | | Account Share | | | | | | | | 3.1 | | 2.5 | 0 | 5.6 |
| | | Market Share | | | | | | | | 1.7 | | 2.1 | 0 | 3.8 |
| | TOTAL | Items | 1 | 1 | 2 | 2 | 1 | 1 | 3 | 4 | 2 | 3 | 9 | 11 |
| | | Account Share | 3.3 | 3.3 | 8.2 | 8.2 | 0.8 | 0.8 | 10.8 | 13.9 | 3.3 | 5.8 | 26.4 | 32.0 |
| | | Market Share | 2.2 | 2.2 | 4.7 | 4.7 | 1.9 | 1.9 | 9.7 | 11.5 | 7.3 | 9.4 | 25.8 | 29.7 |

The process of using an assortment tool may also take into account the market structure in order to give insight to the segmentation of products. FIG. 1B illustrates market segmentation for bathroom tissue.

In another aspect of the analysis, cross-purchasing analysis may be included in a model to consider the other brands that buyers purchase within a set. For example, the following TABLE 2 illustrates cross-purchasing information.

TABLE 2
CROSS-PURCHASING INFORMATION

| | Bath Tissue Brand Buyers | | | | | | | | | |
|---|---|---|---|---|---|---|---|---|---|---|
| Brand | A | B | C | D | E | F | G | H | I | J |
| A | 100 | 28.4 | 39.2 | 44.3 | 44.4 | 41.8 | 25.4 | 24.8 | 26.8 | 31.1 |
| B | 20.69 | 100 | 14.6 | 15.8 | 17.2 | 18.2 | 10.0 | 58.8 | 68.8 | 24.1 |
| C | 57 | 29.2 | 100 | 51.6 | 50.8 | 49.2 | 39.0 | 26.5 | 21.5 | 39.4 |
| D | 54.93 | 26.9 | 44.0 | 100 | 52.5 | 51.9 | 47.2 | 28.0 | 31.4 | 38.9 |
| E | 46.29 | 24.6 | 36.5 | 44.2 | 100 | 57.0 | 1.0 | 27.9 | 27.4 | 40.5 |
| F | 25.93 | 15.5 | 21.0 | 26.0 | 33.8 | 100 | 22.8 | 19.5 | 22.4 | 27.8 |
| G | 3.9 | 2.1 | 4.1 | 5.8 | 2.5 | 5.6 | 100 | 0.0 | 0.0 | 8.2 |
| H | 4.84 | 15.7 | 3.6 | 4.4 | 5.2 | 6.1 | 0.0 | 100 | 48.1 | 9.0 |
| I | 1.64 | 5.8 | 0.9 | 1.6 | 1.6 | 2.2 | 0.0 | 15.1 | 100 | 2.9 |
| J | 37.87 | 40.2 | 33.0 | 38.1 | 47.1 | 54.6 | 65.0 | 56.1 | 57.9 | 100 |
| Index | 105 | 78 | 81 | 96 | 105 | 118 | 94 | 106 | 126 | 92 |

Brands may be rolled up in the analysis. A displayed sheet can then be populated by information included dollar sales and market segment. Brands are combined to give fair representation in the market. An example would include private label or store brands which are disadvantaged when compared to the market due to distribution in a chain versus the market. The roll up functionality allows the user to combine like items so the true value of that type of item can be determined. New items can also be added in this worksheet and the correct designations for brand, segment, and potential sales volume.

Each category can then be segmented into separate tabs on a spreadsheet and the model can then be aligned with information for a specific customer by segment. Items can then be selected and considered separately. Each assortment can be evaluated in light of market information based on household panel data or other information sources (market penetration, loyalty, etc.). The following TABLE 3 illustrates an example of evaluation in light of market information.

TABLE 3

| | | | | | | | # of | Add/ |
|---|---|---|---|---|---|---|---|---|
| | | Pene- | | | | | Items | Delete |
| | Strat- | tra- | Loy- | Occ/ | Dol/ | Add'l | in | Items |
| | egy | tion | alty | Buyer | Occ | Data | POG | (+/−) |
| Economy | | 24.7 | 33.3 | 3.8 | 2.67 | | 8 | 0 |
| Regular | | 31.1 | 46.7 | 3.9 | 3.27 | | 9 | 0 |
| Premium | | 53.1 | 64.7 | 4.2 | 4.18 | | 9 | 0 |
| Super | | 24.7 | 34.1 | 2.7 | 4.24 | | 1 | 0 |
| Premium | | | | | | | | |

Table 3 is an opportunity for the user to evaluate the distribution of product segments in the current planogram to Household panel information and to then adjust the number of items based on that information.

In another aspect, account information may be applied and market coverage may be determined in light of market data and demographic data. For example, a PARETO curve may be used to examine cumulative sales dollar share to find the point of diminishing returns for account and to find the market (e.g., where additions bring less than 1% of sales volume to the category or segment). The tool also allows the user to incorporate market information, account sales information and household panel information into the analysis. As a result, the recommended number of items for optimum return can be compared to targets. For example, the following TABLE 4 illustrates a comparison of targets versus recommendations based on various categories of items.

TABLE 4

| | Target # | Recommended # |
|---|---|---|
| | of Items | of Items |
| Economy | 4 | 5 |
| Regular | 14 | 14 |
| Premium | 16 | 16 |
| Super Premium | 1 | 1 |

However, the above analysis does not resolve all the decisions that need to be made in the marketing and sales of products and in the determination of an assortment for retail placement. For example, there is a need to take into account additional product information such as shelf space data to better understand shelf space allocation. There is also a need to take into account such things as data relating to inventory, promotions and forecasting. Further, peripherally related sales data may also be of interest in the analysis process. Thus, there is a need for an allocation tool which can adjust the selected product assortment based on such additional product data.

### SUMMARY OF THE INVENTION

The allocation tool according to the invention includes in one embodiment a shelf space management tool to further strengthen the business value of the tool. The shelf space management is linked to the assortment selection tool and the resulting selected product assortment provided by the assortment selection tool. It has been found that a proposed assortment may often require further modifications when shelf space and product dimensions are considered in light of expected sales.

Other optional aspects of the allocation tool according to the invention include integration with shelf space management tools, inventory tracking tools, forecasting tools, and promotion planning tool. Such integration allows vendors and distributors to select and/or modify an assortment of products and the shelf space allocation of those products in order to increase or maximize returns. The tool may also be used to show distributors the expected returns for various scenarios allowing market claims to be supported.

In another optional embodiment of the invention, Nielsen Report information may be aligned with the products of an assortment being considered for retail placement. In this process, a software interface may be used to convert Nielsen numbers into correct UPC numbers. In cases where two or more separate UPC numbers are rolled up into a single Nielsen number, unrolling may be needed. The allocation tool according to the invention may also be optionally used to sort results by brand or in a variety of customized ways.

The assortment tool of the invention may also optionally be interfaced with a virtual retail environment to allow marketers, retailers and consumers to evaluate a variety of alternative arrangements and product assortments. Virtual retail environment technology which is available off the shelf may be used in combination with the allocation tool so that a proposed efficient assortment can be virtually laid out in an isle in a store to allow people to virtually explore the new isle. Consumer response can then be evaluated and the layout further modified.

In one form, the invention comprises a system for determining an assortment of a plurality of related products for retail placement. An assortment selection tool selects one or more of the plurality of products as a function of product data in order to define a selected product assortment. A database of product data includes at least one of the following: shelf space data, product dimension data, inventory tracking data, promotion planning data, forecasting data and sales data. An allocation tool adjusts the selected product assortment as a function of the product data in the database to define an allocated product assortment for retail placement.

In another form, the invention comprises a system for evaluating the retail placement of related products. A tool defines a product assortment. A database of product data includes at least one of the following: shelf space data, product dimension data, inventory tracking data, promotion planning data, forecasting data and sales data. A virtual environment interface permits marketers, retailers and/or consumers evaluate the product assortment in a virtual environment as a function of the product data in the database to define an allocated product assortment for retail placement.

In another form, the invention comprises a method for determining an assortment of a plurality of related products for retail placement. One or more of the plurality of products is selected as a function of product data in order to define a selected product assortment. Product data is collected including at least one of the following: shelf space data, product dimension data, inventory tracking data, promotion planning data, forecasting data and sales data. The selected product assortment is adjusted as a function of the collected product data to define an allocated product assortment for retail placement.

In another form, the invention comprises a method for evaluating the retail placement of related products. A product assortment is defined. Product data is collected including at least one of the following: shelf space data, product dimension data, inventory tracking data, promotion planning data, forecasting data and sales data. The product assortment is evaluated in a virtual environment as a function of the collected product data in the database to define an allocated product assortment for retail placement.

### BRIEF DESCRIPTION OF THE DRAWINGS

FIG. 1A is a block diagram of a prior art system including an assortment selection tool for defining a selected product assortment for a plurality of related products based product data.

FIG. 1B is a block diagram of a prior art market structure considered to give insight into the segmentation of products.

FIG. 2 is a block diagram of a system according to one embodiment of the invention including an assortment selection tool in combination with an allocation tool responsive to a database of additional product data for defining an allocated product assortment.

FIG. 3 is a block diagram of the allocation tool and database according to one embodiment of the invention.

FIGS. 4A and 4B are examples of tables which may be generated by the shelf space management tool 302 for use by an operator to assist in adjusting the selected product assortment as a function of the product data in the database to define an allocated product assortment for retail placement.

FIG. 5 illustrates the buyers of products 1, 2 and 3 represented by circles.

FIG. 6 is a block diagram of a system according to one embodiment of the invention including a virtual retail environment interface in combination with an assortment selection tool and an allocation tool responsive to a database of additional product data.

### DETAILED DESCRIPTION OF THE INVENTION

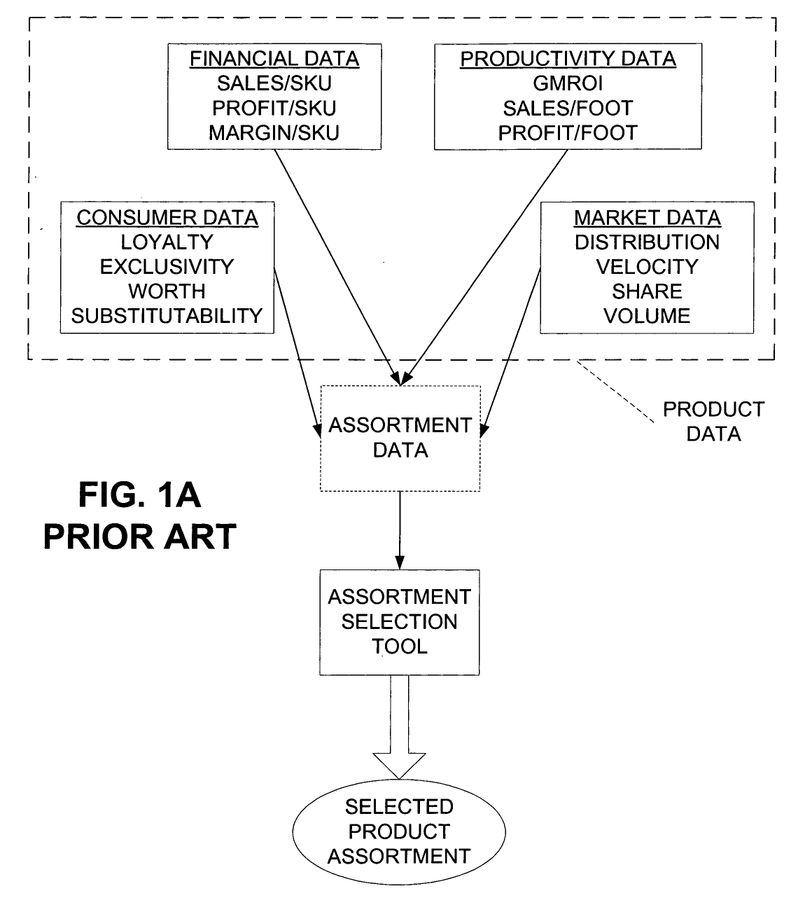

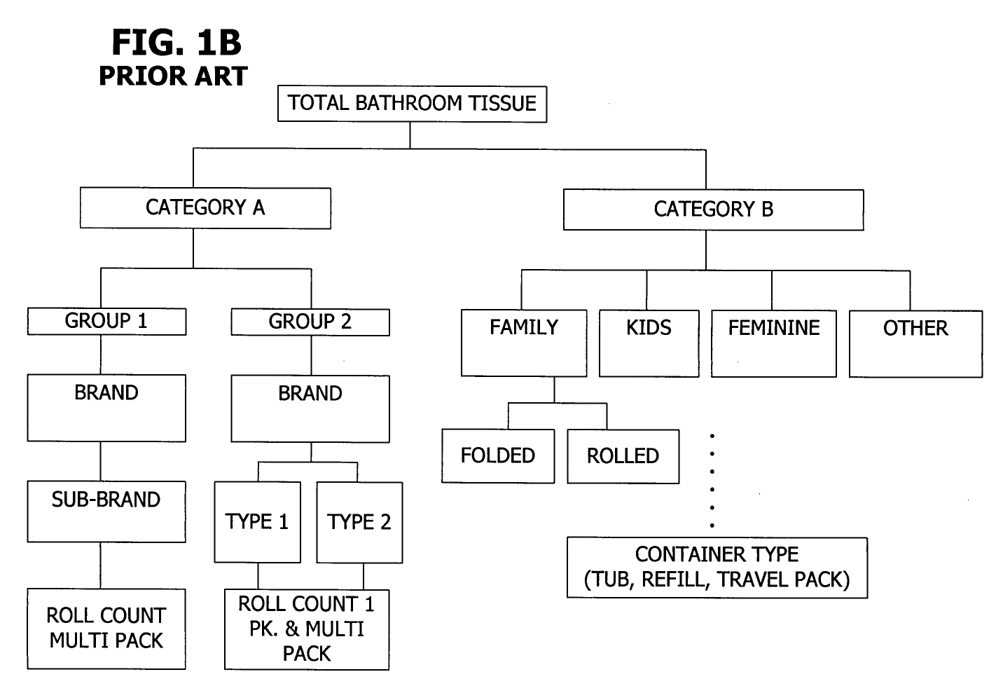

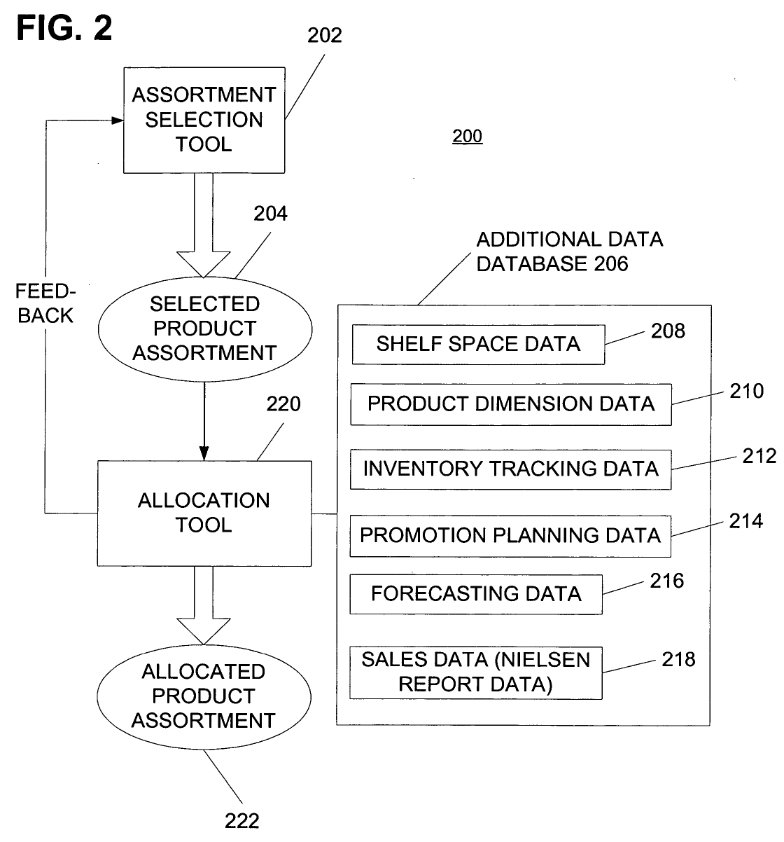

FIG. 2 illustrates a system 200 according to the invention for determining an allocated assortment of a plurality of related products for retail placement. An assortment selection tool 202 such as the tool illustrated in FIG. 1A selects one or more of the plurality of products as a function of the consumer, financial, productivity and/or market data in order to define a selected product assortment 204. In one embodiment, the assortment selection tool 202 may include a graphical user interface for selecting product category assortments. A database 206 of additional product data is compiled and/or updated to include at least one of the following: shelf space data 208, product dimension data 210, inventory tracking data 212, promotion planning data 214, forecasting data 216 and sales data (e.g., Nielsen Report data) 218. The additional product data in the database 206 is available along with the selected product assortment 204 to an allocation tool 220 for adjusting the selected product assortment as a function of the additional product data in a database 206. In one embodiment, the allocation tool 220 may include a graphical user interface so that a user can monitor, select and/or modify the allocated product assortment. As a result, the allocation tool 220 defines an allocated product assortment 222 for retail placement.

In one embodiment of the invention, the allocation tool 220 adjusts which products are included as selected products which make up the selected product assortment 204. The adjustment can take the form of adding additional products or deleting products of the assortment. For example, the allocation tool 220 may add one or more products to the selected product assortment 204 to increase the number of selected products which define the allocated product assortment 222. Alternatively, the allocation tool 220 may remove one or more products from the selected product assortment 204 to decrease the number of selected products which define the allocated product assortment 222.

In one embodiment of the invention, the allocation tool provides feedback information to the assortment selection tool so that the assortment selection tool may adjust the selected product assortment 204 and the allocation tool 220 can re-evaluate the adjusted selected product assortment. For example, the allocation tool 220 may generate feedback indicating a change to the selected product assortment 220. The assortment selection tool 202 is responsive to the feedback from the allocation tool 220. The assortment selection tool 202 adjusts the selected product assortment 204 based on the feedback and/or based on user input from a graphical user interface. More specifically, if the allocation tool 220 determines that a product needs to be added to the selected product assortment 204, this information would be provided to the assortment selection tool 202 to adjust the selected product assortment 204 accordingly to add the additional product. Conversely, if the allocation tool 220 determines that a product needs to be removed from the selected product assortment 204, this feedback information would be provided to the assortment selection tool 202 to reduce the selected product assortment 204 by the deleted product. After adjusting the selected product assortment 204, the allocation tool would then operate on the selected product assortment 204 according to the additional product data in database 206. This feedback process may take the form of an iterative process which converges to a solution. Alternatively, the feedback process could be a single feedback loop which would re-evaluate an allocated product assortment 222 after receiving a recommendation by the allocation tool 220.

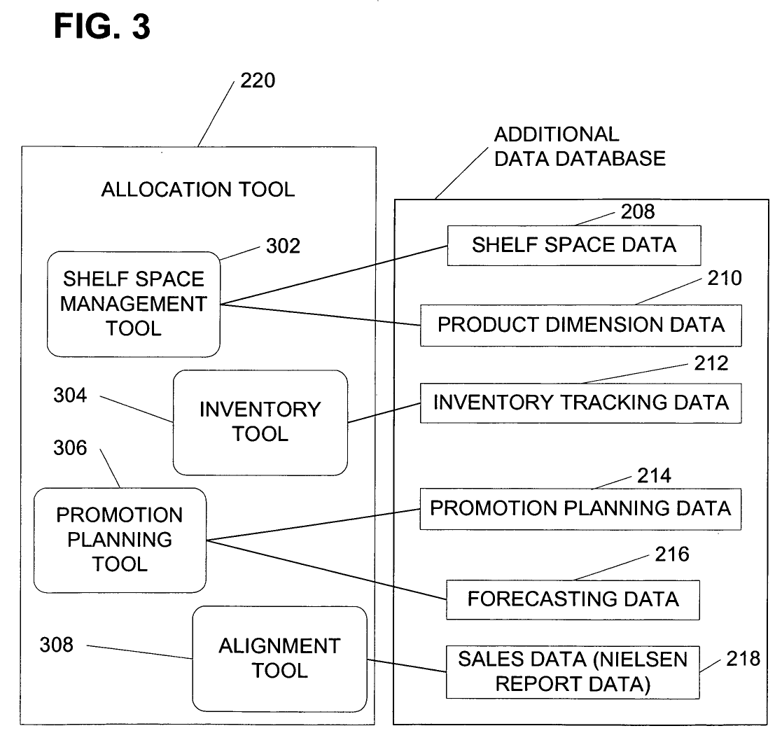

Referring to FIG. 3, a block diagram of the allocation tool 220 according to one embodiment of the invention is illustrated. In one embodiment, the allocation tool 220 may optionally include a shelf space management tool for allocating a portion of a preset amount of shelf space to each selected product as a function of the shelf space data 208 and as a function of the product dimension data 210. In one embodiment, the shelf space management tool 302 may include a screen shot illustrating the shelf space data 208 and the product dimension data 210 along with the allocated product assortment 222 so that a user may simultaneously view this information and determine whether or not to make any adjustments to the allocated product assortment. In another embodiment, the shelf space management tool 302 may include an algorithm which adjusts the allocated product assortment based on either the shelf space data 208, based on the product dimension data 210 or based on both data.

For example, it has been found that a proposed assortment may often require further modifications when shelf space and product dimensions are considered in light of expected sales. In particular, a certain number of facings may be proposed with the assortment selection tool as an optimum assortment (e.g., via a graphical user interface), but some of the products of the assortment may have shelf space demands that require additional facings. Thus, according to the allocation tool of the invention it may prove to be more profitable to adjust the product assortment to offer a smaller number of products to allow some to occupy two or more facings.

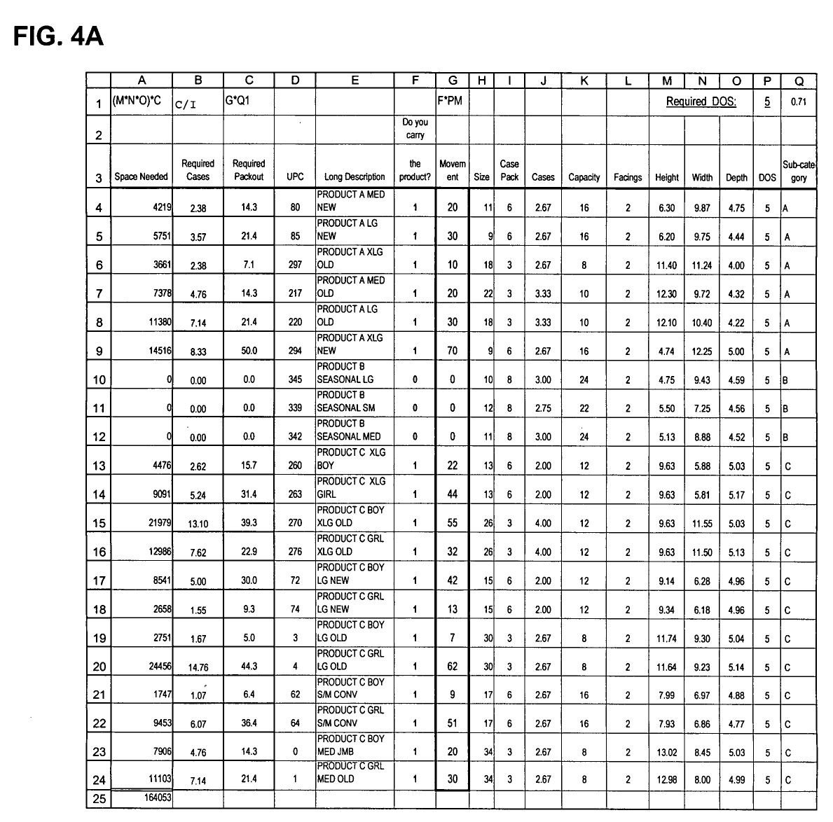

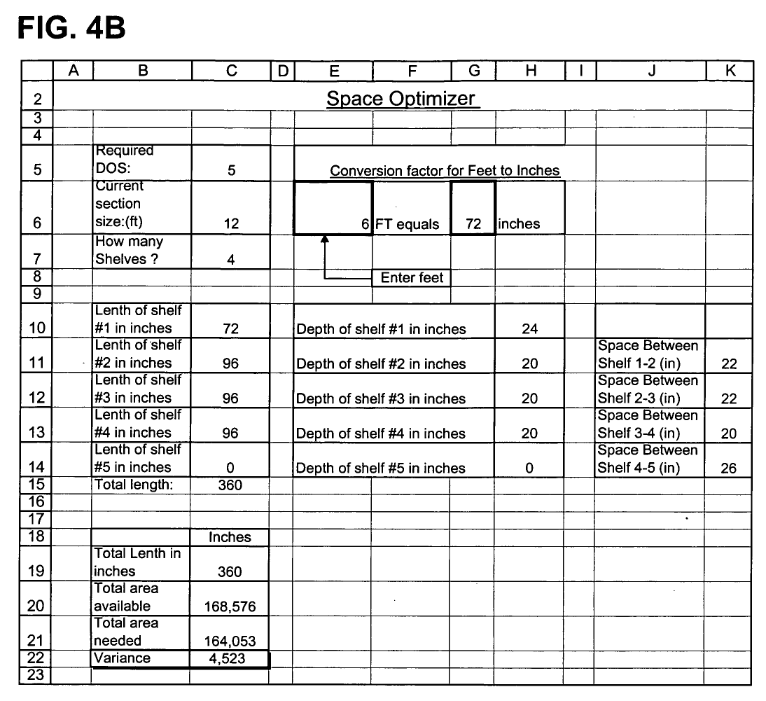

FIGS. 4A and 4B are examples of tables which may be generated by the shelf space management tool 302 for use by an operator to assist in adjusting the selected product assortment as a function of the product data in the database to define an allocated product assortment for retail placement. In one form, the tables are spread sheets generated from the database of product data populated by shelf space data and product dimension data. As noted below, such tables may also be populated with inventory tracking data, promotion planning data, forecasting data and sales data.

As shown in FIG. 4A, the table includes columns D, E and Q which identify the UPC code, long description and category of the product assortment. Column I indicates the number of products per case pack. Columns M, N and O, which specify each product's dimensions. Column P indicates the days of supply (DOS) which, in this example, is set at 5 per week or 0.71 per day as indicated by cell Q1. Column G identifies the movement of each product. The product movement multiplied by the daily DOS (e.g., G*Q1) indicates the required packout, noted in column C. The product dimensions multiplied by the required packout (e.g., M*N*O*C) indicates the shelf space needed, as noted in column A. Column F indicates which products are being carried. In one embodiment, this number in column F (1 for carried and 0 (zero) for not carried) may be changed manually or by an algorithm to determine the better product assortment. In this embodiment, the movement specified in column G may be the number in column F multiplied by the product movement (PM). Thus, the seasonal products in rows 10-12 are not being carried in the illustrated product assortment and their movement is zero.

FIG. 4B is populated with the shelf space information in order to calculate the total shelf space length (e.g., 360 inches) and the total available area (e.g., 168,576.00 sq. in.). This total available area is compared against the total area needed (e.g., 164,053 sq. in.), indicated by cell A25 in the table of FIG. 4A, which is the sum of column A. The difference is the variance (e.g., 4,523 sq. in. are available).

In another embodiment, the allocation tool 220 may optionally include an inventory tool 304 for allocating a portion of a preset amount of shelf space to each selected product as a function of inventory tracking data 212. In one embodiment, the inventory tool 304 may verify that the amount of allocated shelf space according to the allocated product assortment 222 is less than the available inventory as indicated by the inventory tracking data 222. In other words, if insufficient inventory is available to fill the shelf space either presently or in the future based on projected sales, the inventory tool 304 would modify the allocated product assortment 222 so that the shelf space for a particular product would be equivalent to its inventory. In another embodiment, the inventory tool 304 may take into account inventory over time and sales over time to manage the shelf space over time to confirm that the shelf space would never exceed the available inventory.

The table of FIG. 4A includes additional information which may be generated by other tools. For example, the packout multiplied by the case per pack (e.g., C*I) identifies the required cases, noted in column B, which may be used by the inventory tool 304. The inventory tool may also use columns F, J, K and L.

In one embodiment of the invention, the allocation tool 220 includes a promotion planning tool 306 which is responsive to promotion planning data 214 and forecasting data 216. In one embodiment, the promotion planning tool would automatically increase shelf space by a particular percentage in advance of or simultaneously with a promotion for a particular product as indicated by the promotion planning data 214. Alternatively, the forecasting data 216 may include seasonal forecasting data which would be provided to the promotion planning tool 306. The tool 306 would adjust the shelf space according to this seasonal forecasting data 216. The promotion planning tool 306 would be responsive to a promotional calendar and would accommodate for the promotional calendar by anticipating the need for shelf space and/or distribution.

In another embodiment, the allocation tool 220 may include an alignment tool 308 which is responsive to sales data 218, such as Nielsen Report data. The alignment tool 308 would adjust the allocated product assortment 222 to match any sales data 218. Alternatively, the alignment tool 308 may average the sales data information with the allocated product assortment 222 to revise the assortment. For example, as noted above, Nielsen Report information may be aligned with the products of an assortment being considered for retail placement. In this process, a software interface may be used to convert Nielsen numbers into correct UPC numbers. In cases where two or more separate UPC numbers are rolled up into a single Nielsen number, unrolling may be needed. The allocation tool according to the invention may also be optionally used to sort results by brand or in a variety of customized ways.

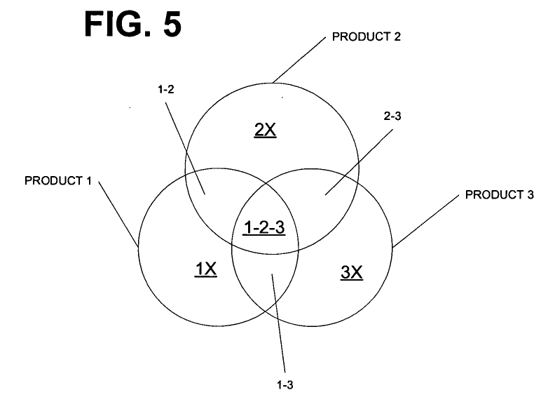

In another optional embodiment, the allocation tool may take into account household panel worth and loyalty. Household panel exclusivity is the percentage of a brand or a percentage of segment buyers that purchase only that brand or segment. For example, the circles in FIG. 5 illustrate the buyers of products 1, 2 and 3. The overlapping areas 1-2, 1-3, 2-3 between two circles (about ⅙ of each circle) indicate the percentage of buyers the purchase both products. The overlapping area 1-2-3 of all three circles (about ⅙ of each circle) indicates the percentage of buyers which purchase all three products. The areas 1X, 2X, 3X of each circle (about ½ of each circle) which do not overlap indicate the percentage of buyers which buy only that product.

The percent of a brand or segment that purchases products competitive with a product is also illustrated by FIG. 5. The percent of product 1 buyers that also purchase product 2 (and vice verse) is the overlap of circles 1 and 2, i.e., 1-2 and 1-2-3; about ⅙. The percent of product 1 buyers that also purchase product 3 (and vice verse) is the overlap of circles 1 and 3, i.e., 1-3 and 1-2-3; about ⅙. The percent of product 2 buyers that also purchase product 3 (and vice verse) is the overlap of circles 2 and 3, i.e., 2-3 and 1-2-3; about ⅙.

Thus, FIG. 5 illustrates cross-purchasing, which is the percentage of a brand or segment that purchases a competitive brand or segment. As a result, household panel worth is the total category dollars spent by the buyer in question. This information may be part of the database. In other words, the product data in the database includes categories, wherein each product is classified in one of the categories, and wherein each product has a category amount indicating its proportional value (e.g., household panel worth) compared to its category. In this embodiment, the allocation tool adjusts the selected product assortment as a function of the category amount.

The information in FIG. 5 also indicates loyalty. In particular, it shows a given brand or segment's share among its buyers. In the example of FIG. 5, each product 1 buyers fulfill 50% of their product requirements from product 1, product 2 buyers fulfill 50% of their product requirements from product 2, and product 3 buyers fulfill 50% of their product requirements from product 3. Thus, household panel loyalty refers to the given brand name or segment share among its buyers. This information may also be part of the database. In other words, the product data in the database includes categories, wherein each product is classified in one of the categories, and wherein each product has a segment share indicating its exclusive purchasing power (e.g., household panel loyalty) compared to the purchasing power of other products in its category. In this embodiment, the allocation tool adjusts the selected product assortment as a function of the segment share.

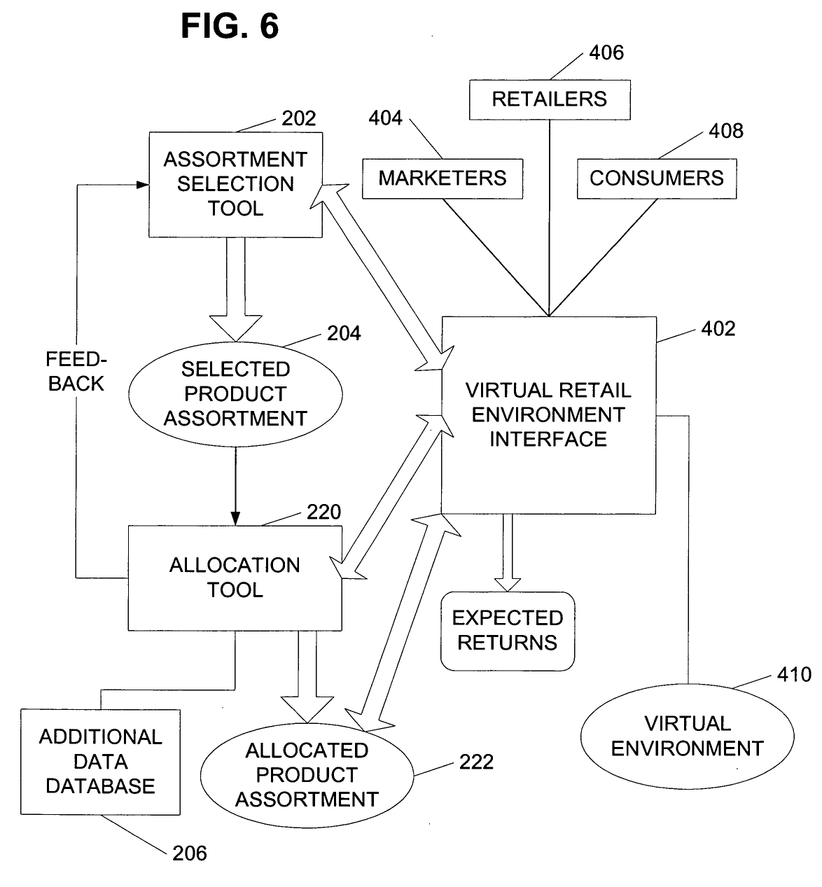

FIG. 6 illustrates a block diagram of a system according to one embodiment of the invention including a virtual retail environment interface 402 in combination with the assortment selection tool 202 and the allocation tool 220. In general, the system of FIG. 6 may be any tool for defining a product assortment in combination with the virtual environment interface 402 for permitting marketers 404, retailers 406 and/or consumers 408 to evaluate the selected product assortment 204 in a virtual environment 410. As noted above, the evaluation would occur as a function of additional product data in database 206 in order to define an allocated product assortment 222 for retail placement. In one embodiment, the interface 402 would allow selected users to manipulate the allocated product assortment 222 according to the results of analyzing the product assortment according to the virtual environment 410. In one embodiment of the invention, the virtual retail environment interface 402 would interact with both the assortment selection tool 202 and the allocation tool 220 in order to provide input to either or both which would effect or modify the selected product assortment 204 and which would effect or modify the allocated product assortment 222. Further, the assortment selection tool 202 may include a graphical user interface for permitting the user to select and/or modify product category assortments.

As a result, the invention includes a business method for determining an assortment of a plurality of related products for retail placement. Initially, one or more of a plurality of products is selected as a function of product data (consumer, financial, productivity and/or marketing data) in order to define a selected product assortment 204. This may be done by an assortment selection tool 202. Additional product data is collected and optionally stored in database 206 and may include one or more of the following: shelf space data 208, product dimension data 210, inventory tracking data 212, promotion planning data 214, forecasting data 216 and sales data 218. The user (either manually or by employing the allocation tool 220) would adjust the selected product assortment 204 as a function of the collected additional product data in the database to define the product assortment 222 for retail placement. In one form, the method may be implemented by a computer readable medium including instructions for performing the method.

In one embodiment, the invention comprises a business method for evaluating the retail placement of related products. This method may be performed manually or with the use of tools as noted above. In either case, a product assortment 204 is defined and additional product data is collected (e.g., in database 206). The product assortment 204 is evaluated in a virtual environment 410 via interface 402 as a function of the collected additional product data in the database to define an allocated product assortment 222 for retail placement. In one form, the method may be implemented by a computer readable medium including instructions for performing the method.

What is claimed is:

1. A system for determining an assortment of a plurality of related products for retail placement comprising:
an assortment selection tool for selecting one or more of the plurality of products as a function of product data in order to define a selected product assortment;
a database of product data including at least one of the following: shelf space data, product dimension data, inventory tracking data, promotion planning data, forecasting data and sales data; and
an allocation tool for adjusting the selected product assortment as a function of the product data in the database to define an allocated product assortment for retail placement.

2. The system of claim 1 wherein the product data comprises at least one of the following: consumer data, financial data, productivity data and market data.

3. The system of claim 1 wherein the allocation tool generates feedback indicating a change to the selected product assortment, wherein the assortment selection tool includes a graphical user interface for selecting product category assortments, wherein the assortment selection tool includes a graphical user interface so that a user can monitor, select and/or modify the allocated product assortment, wherein the assortment selection tool is responsive to the feedback from the allocation tool and wherein the assortment selection tool adjusts the selected product assortment based on the feedback.

4. The system of claim 1 wherein the allocation tool adjusts the selected products by adding one or more products to the selected product assortment to increase the number of selected products which define the allocated product assortment or by removing one or more products from the selected product assortment to decrease the number of selected products which define the allocated product assortment.

5. The system of claim 1 wherein the allocation tool comprises a shelf space management tool for allocating a portion of a preset amount of shelf space to each selected product as a function of shelf space data and as a function of product dimension data.

6. The system of claim 1 wherein the allocation tool comprises an inventory tool for allocating a portion of a preset amount of shelf space to each selected product as a function of inventory tracking data.

7. The system of claim 1 wherein the allocation tool comprises a promotion planning tool for allocating a portion of a preset amount of shelf space to each selected product as a function of promotion planning data and the forecasting data.

8. The system of claim 1 wherein the allocation tool comprises an alignment tool for allocating a portion of a preset amount of shelf space to each selected product as a function of sales data.

9. The system of claim 1 wherein the product data in the database includes categories, wherein each product is classified in one of the categories, wherein each product has a segment share indicating its exclusive purchasing power compared to the purchasing power of other products in its category and wherein the allocation tool adjusts the selected product assortment as a function of the segment share.

10. The system of claim 1 wherein the product data in the database includes categories, wherein each product is classified in one of the categories, wherein each product has a category amount indicating its proportional value compared to its category and wherein the allocation tool adjusts the selected product assortment as a function of the category amount.

11. A system for evaluating the retail placement of related products comprising:
a tool for defining a product assortment;
a database of product data including at least one of the following: shelf space data, product dimension data, inventory tracking data, promotion planning data, forecasting data and sales data; and
a virtual environment interface for permitting marketers, retailers and/or consumers evaluate the product assortment in a virtual environment as a function of the product data in the database to define an allocated product assortment for retail placement.

12. The system of claim 11 wherein the tool comprises at least one of an assortment selection tool and allocation tool, wherein the assortment selection tool includes a graphical user interface for selecting product category assortments, and wherein the allocation tool comprises at least one of a shelf space management tool, an inventory tool, a promotion planning tool and an alignment tool.

13. The system of claim 12 wherein the allocation tool generates feedback indicating a change to the selected product assortment, wherein the assortment selection tool includes a graphical user interface for selecting product category assortments, wherein the assortment selection tool is responsive to the feedback from the allocation tool, wherein the assortment selection tool includes a graphical user interface for selecting product category assortments, and wherein the assortment selection tool adjusts the selected product assortment based on the feedback.

14. The system of claim 12 wherein the allocation tool adjusts the selected products by adding one or more products to the selected product assortment to increase the number of selected products which define the allocated product assortment or by removing one or more products from the selected product assortment to decrease the number of selected products which define the allocated product assortment.

15. The system of claim 11 wherein the product data comprises at least one of the following: consumer data, financial data, productivity data and market data.

16. A method for determining an assortment of a plurality of related products for retail placement comprising:
selecting one or more of the plurality of products as a function of product data in order to define a selected product assortment;
collecting product data including at least one of the following: shelf space data, product dimension data, inventory tracking data, promotion planning data, forecasting data and sales data; and
adjusting the selected product assortment as a function of the collected product data to define an allocated product assortment for retail placement.

17. The method of claim 16 wherein the product data comprises at least one of the following: consumer data, financial data, productivity data and market data.

18. The method of claim 16 further comprising generating feedback indicating a change to the selected product assortment and responding to the feedback to adjust the selected product assortment based on the feedback.

19. The method of claim 16 further comprising adjusting the selected products by adding one or more products to the selected product assortment to increase the number of selected products which define the allocated product assortment or by removing one or more products from the selected product assortment to decrease the number of selected products which define the allocated product assortment.

20. The method of claim 16 further comprising allocating a portion of a preset amount of shelf space to each selected product as a function of shelf space data and as a function of product dimension data.

21. The method of claim 16 further comprising allocating a portion of a preset amount of shelf space to each selected product as a function of inventory tracking data.

22. The method of claim 16 further comprising allocating a portion of a preset amount of shelf space to each selected product as a function of at least one of promotion planning data, forecasting data and sales data.

23. A computer readable medium including instructions for performing the method of claim 16.

24. The method of claim 16 wherein the product data includes categories, wherein each product is classified in one of the categories, wherein each product has a segment share indicating its exclusive purchasing power compared to the purchasing power of other products in its category and wherein the adjusting adjusts the selected product assortment as a function of the segment share.

25. The method of claim 16 wherein the product data includes categories, wherein each product is classified in one of the categories, wherein each product has a category amount indicating its proportional value compared to its category and wherein the adjusting adjusts the selected product assortment as a function of the category amount.

26. A method for evaluating the retail placement of related products comprising:
defining a product assortment;
collecting product data including at least one of the following: shelf space data, product dimension data, inventory tracking data, promotion planning data, forecasting data and sales data; and
evaluating the product assortment in a virtual environment as a function of the collected product data in the database to define an allocated product assortment for retail placement.

27. The method of claim 26 further comprising generating feedback indicating a change to the selected product assortment and responding to the feedback to adjust the selected product assortment based on the feedback.

28. The method of claim 26 further comprising adjusting the selected products by adding one or more products to the selected product assortment to increase the number of selected products which define the allocated product assortment or by removing one or more products from the selected product assortment to decrease the number of selected products which define the allocated product assortment.

29. The method of claim 26 wherein the product data comprises at least one of the following: consumer data, financial data, productivity data and market data.

30. A computer readable medium including instructions for performing the method of claim 26.
